(19) United States
(12) Patent Application Publication
(10) Pub. No.: US 2012/0067299 A1
(43) Pub. Date: Mar. 22, 2012

(54) Collar for Animals, in Particular Dogs, with a Click Lock

(76) Inventors: Valentin Völlmecke, Iserlohn (DE); Reinhardt Tiesler, Iserlohn (DE)

(21) Appl. No.: 13/320,118

(22) PCT Filed: Mar. 23, 2010
(86) PCT No.: PCT/EP10/53794

§ 371 Date: Nov. 11, 2011

(30) Foreign Application Priority Data
May 11, 2009 (DE) 10 2009 020 716.3

(51) Int. Cl. A01K 27/00

(52) U.S. Cl. 119/863

(57) ABSTRACT

The collar for animals, in particular dogs, has a fastener which is designed as a click lock and has a housing (20) and a locking tongue (22). The housing (20) and locking tongue (22) can be plugged in in a plug-in direction (24). The housing (20) and the locking tongue (22) each have an end piece (46). A lead can be releasably fastened to a lead ring (26). A neck part (28) can be connected to the fastener to form a ring; said neck part has two connecting regions (42), each of which is connected to an end piece (46). A bearing opening (64) is formed in the fastener, the bearing opening having an axis line which runs transversely with respect to the plug-in direction (24) and substantially parallel to a central axis (66) of the collar. The lead ring (26) is held pivotably in the bearing opening (64).

The invention relates to a collar for animals, in particular for dogs, comprising a fastening means configured as a click fastener and comprising a housing and a locking tongue, wherein the housing and the locking tongue can be plugged together in a plug-in direction, the housing and the locking tongue each have an end piece, and an opening is formed in each end piece, comprising a leash ring to which a leash can be detachably attached, and comprising a neck part which is connected to the fastening means to form a ring and which has two connecting regions, each of which reaches through one of the two openings.

In the known collar of this type, short connectors are respectively inserted between the fastening means and the neck part; they are made from a textile material. Each connector is fabricated from a strip-shaped material which approximately has the width of the fastening means; it is folded and sewn together. One of these connectors carries the leash ring. The leash ring is disposed approximately centrally in its connector.

Producing and attaching these connectors is a considerable additional effort. Textile strips have to be produced, cut to size, mounted and processed for the connectors. These connector have an influence on the overall appearance of the collar; they are clearly recognizable as separate parts.

A collar for dogs with all the features of the generic portion of the applicable claim 1 is also known from DE 203 19 769 U1. In this case, the neck part is configured as a belt fabricated from nylon or leather and is directly connected to the end pieces. The leash ring is incorporated into this neck part; it is configured as a D-shaped ring. The tile is configured as a click fastener.

A collar for dogs comprising a click fastener is also known from DE 202 05 797 U1. A click fastener is understood to be a separable fastener consisting of two elements, namely a housing and a locking tongue. The locking tongue comprises at least one resilient member that flexes, seen from the center line of the collar, radially towards the outside or parallel to the center line. Other flexing directions are possible but not commonly used. This member reaches through a window provided in the housing. Such click fasteners can be connected by simply plugging them together, like plugging a plug into a socket. They are separated by exerting pressure on the resilient member, so that the latter is pressed out of the latching position within the window and the locking tongue can be pulled free.

This is where the invention comes in. It has set itself the object of further developing and improving the production of the collar of the type mentioned above in such a way that the connectors can be omitted, if possible. Preferably, the collar is supposed to be secured against inadvertent opening.

This object is achieved by a collar for animals, in particular for dogs, comprising a) a fastening means configured as a click fastener and comprising a housing and a locking tongue, wherein the housing and the locking tongue can be plugged together in a plug-in direction, the housing and the locking tongue each have an end piece, and an opening is formed in each end piece, comprising b) a leash ring to which a leash can be detachably attached, and comprising c) a neck part which is connected to the fastening means to form a ring and which has two connecting regions, each of which reaches through one of the two openings; in this case, the leash ring is configured as a D-shaped ring and has a linear area; in the fastening means, a mounting opening is formed which has a center line extending transversely to the plug-in direction and substantially parallel to a central axis of the collar, and the linear area of the D-shaped ring is pivotably accommodated in the mounting opening.

The collar according to the invention requires no connectors. The leash ring now is not carried by a connector but is disposed directly on the fastening means. The fastening means with the leash ring can be inexpensively produced with machines. Manual work, as it is virtually inevitable in the case of the connectors, is now saved. The collar now has a visually more coherent appearance; there is no interruption any more by the connectors. The leash ring can now be grasped better. The attachment of the leash ring to the fastening means offers the possibility that the leash ring protrudes from the fastening means so as to always be ready to grasp, without first having to be lifted into a position ready to grasp as is the case in the prior art. Thus, a leash can be attached to the leash ring with one hand without another hand being required to hold the leash ring itself. Moreover, it is thus avoided that the leash ring can strike the fastening means and thus produce a rattling noise.

In a particularly advantageous embodiment, the neck part is configured as a chain. In this case, any chain is suitable, even so-called training chains, for example. The neck part in particular comprises metal chain links that can be covered by a jacket or the like. Examples for a sheet-metal link chain are apparent from PCT/EP2009/055571.

It is possible to configure the leash ring not in a D-shape, but rather configure it as a circular ring. The mounting opening then accommodates not the linear area of the D, but rather the corresponding round curved area of the leash ring. The mounting opening can be relatively short; it can be formed, for example, in an appendage located on the exterior of the housing.

Preferably, the mounting opening is lined with noise-reducing material, in particular plastic. If possible, a metal part, for example a metal leash ring, is supposed to be prevented from striking a metal housing or the like in order not to let rattling sounds be produced. Suitable measures are carried out for this purpose, for example, stops of plastic are provided or one or the other part is fabricated from plastic; the leash ring can, for example, be made from plastic. In a preferred embodiment, the housing can be fabricated starting with a sheet-metal blank; this sheet-metal blank is bent about several bending lines so that a plug-in opening is formed on the whole. The plug-in tongue fits into the latter.

The collar according to claim 5 is secured against inadvertent opening. For this solution, the applicants claims protection also independently from the solution according to claim 1.

Other advantages and features of the invention become apparent from the other claims as well as from the following description of exemplary embodiments of the invention, which are to be understood not to be limiting and which will be explained below with reference to the drawing.

In the drawing:

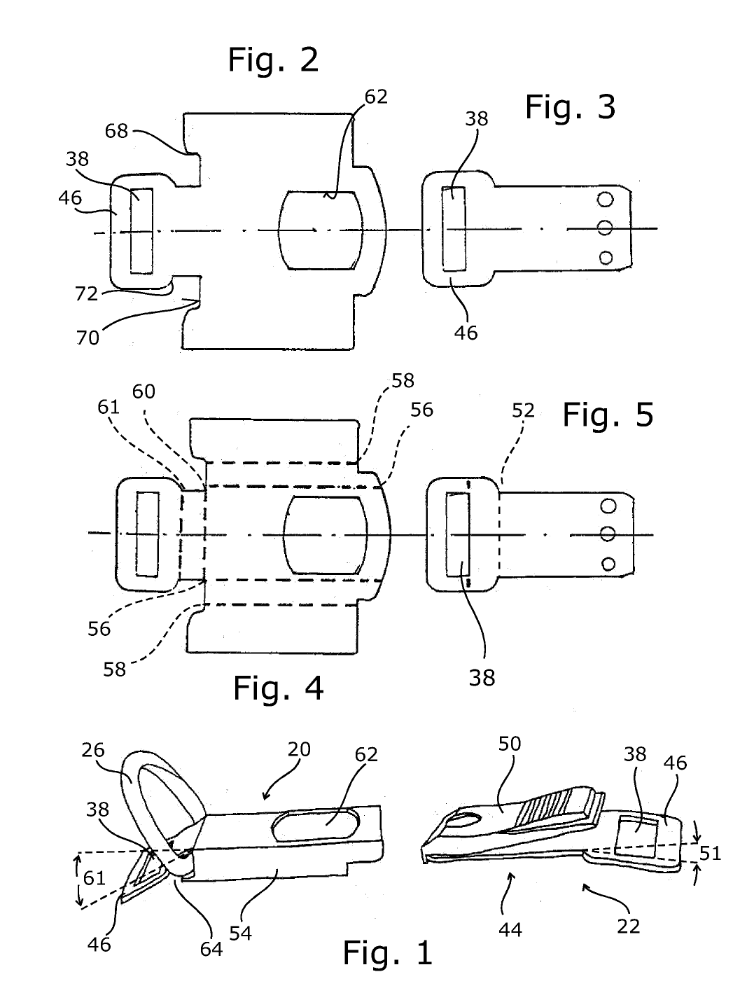

FIG. 1: shows a perspective view of a fastening means configured as a click fastener with a housing and a locking tongue; both are shown separately,

FIG. 2: shows a top view onto a blank of sheet-metal for the housing according to FIG. 1,

FIG. 3: shows a top view onto a blank for a sheet-metal part of the locking tongue,

FIG. 4: shows a top view onto the blank according to FIG. 2, now with bending lines drawn in,

FIG. 5: shows a top view onto the blank according to FIG. 3, with bending line drawn in,

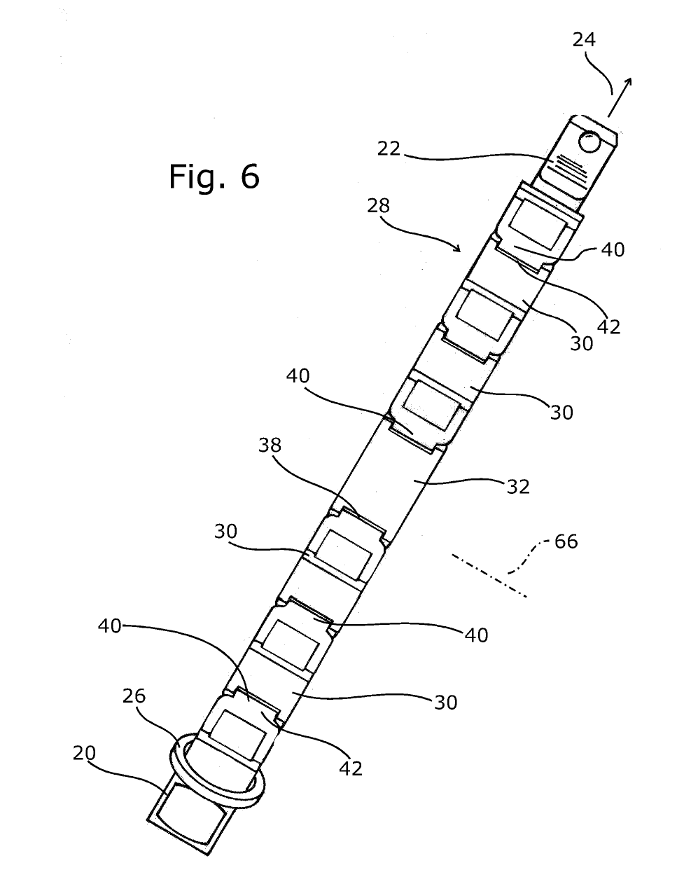

FIG. 6: shows a top view onto a collar manufactured completely from metal,

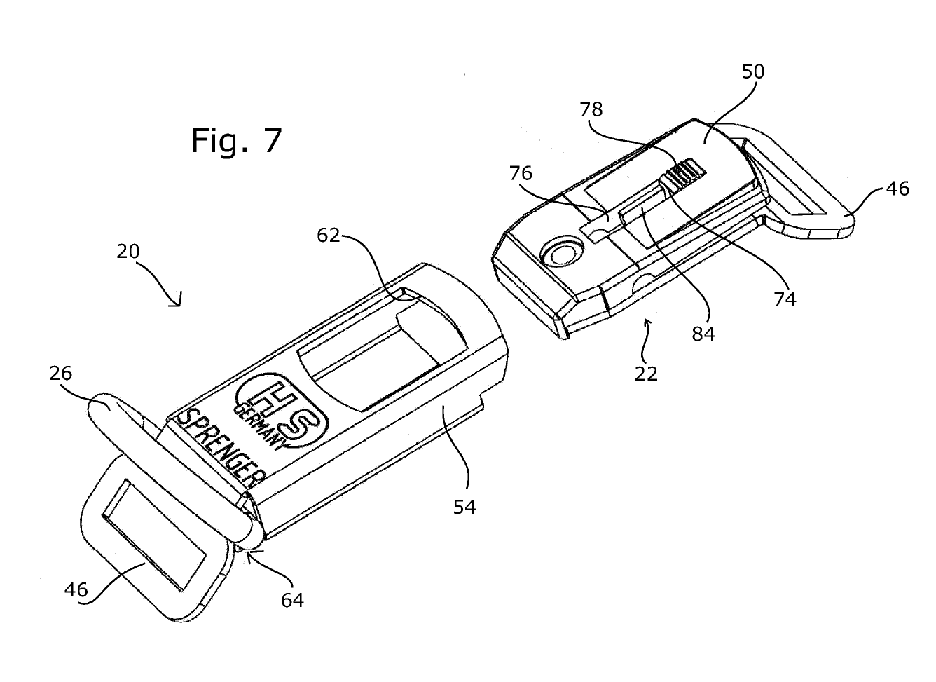

FIG. 7: shows a perspective view similar to FIG. 1, but in this case for a third exemplary embodiment,

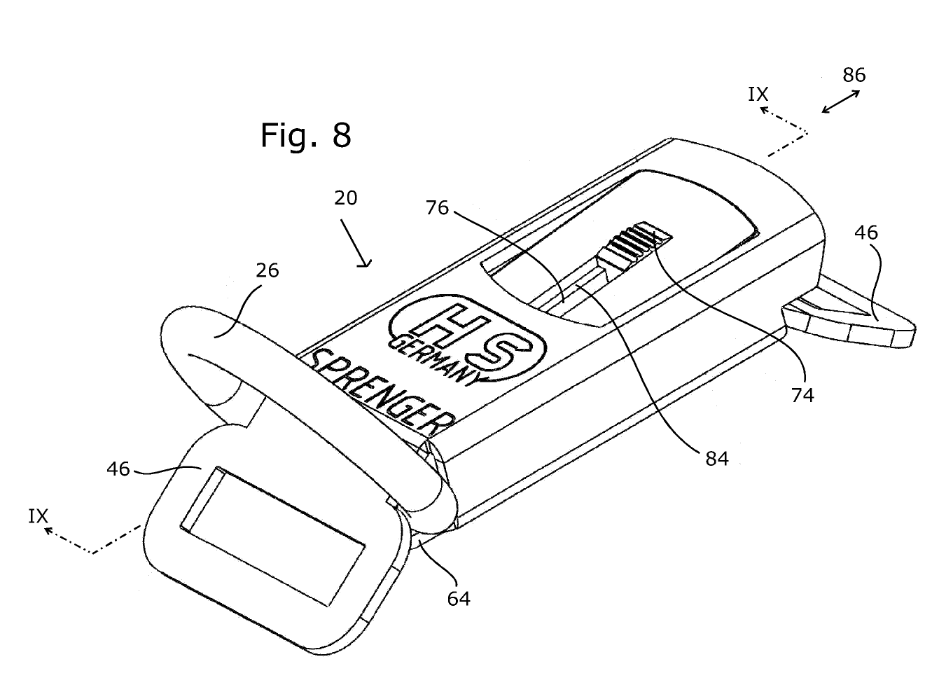

FIG. 8: shows the fastening means according to FIG. 7 in a perspective view and in the locked, but not secured, state,

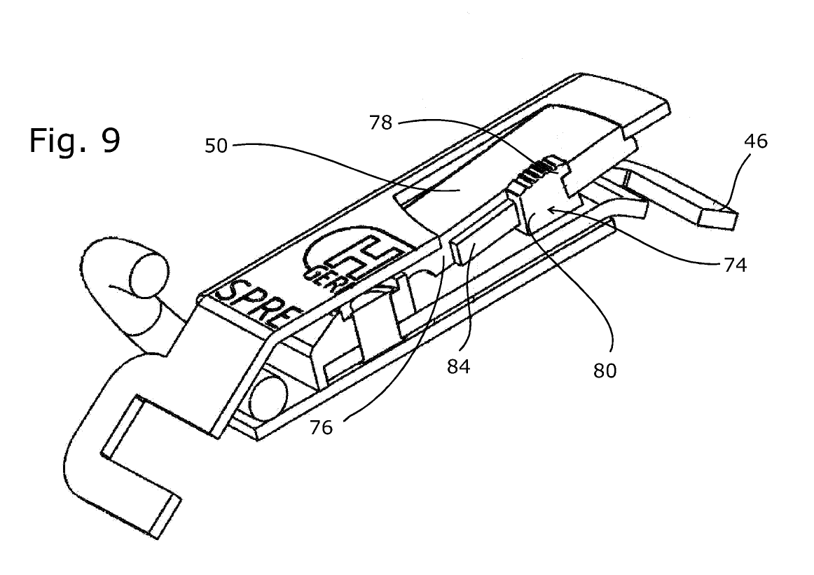

FIG. 9: shows a cut along the sectional plane IX-IX in FIG. 8, and

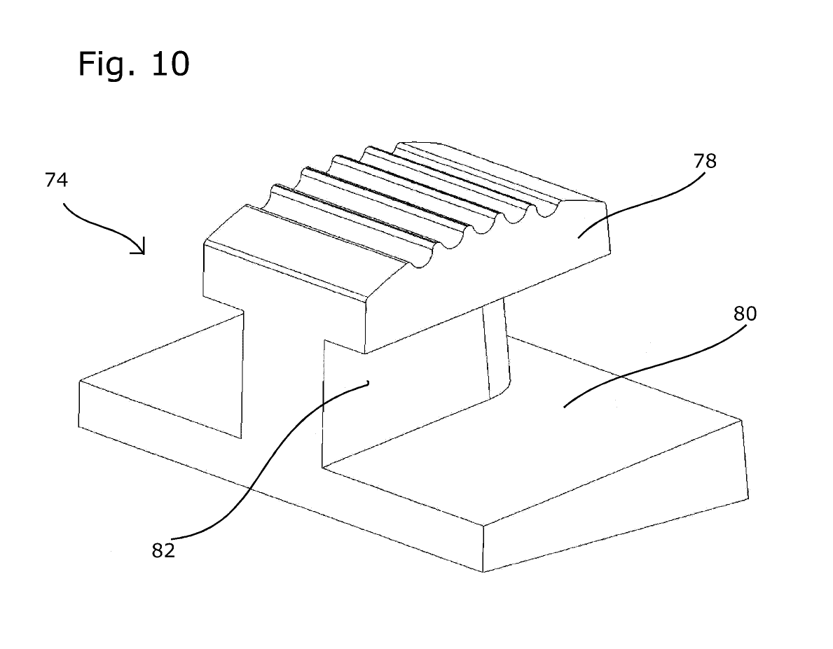

FIG. 10: shows a perspective view of a locking body.

The collar according to FIG. 6 is intended for animals, in particular, it is meant for dogs. It comprises a fastening means which is configured as a click fastener and comprises a housing 20 and a locking tongue 22. They can be connected with each other in a plug-in direction 24 and detached from each other in the opposite direction after depressing the locking tongue 22.

The collar comprises a leash ring 26 to which a leash can be detachably attached, which is in this case not shown in more detail and which is known as such, for example a dog leash. Finally, the collar comprises a neck part 28; it is configured in accordance with the teaching of the above-mentioned PCT/EP2009/055571. It consists of four normal chain links 30 (they are configured in accordance with FIG. 7 of PCT/EP2009/055571), an intermediate link 20 (also see FIG. 4 of the above-mentioned PCT document), the housing 20 and the locking tongue 22. Chain links according to FIG. 13 of the PCT document can be used instead of the normal chain links 30 according to FIG. 7.

The first embodiment according to the FIGS. 1 to 5 will be discussed first. In this first exemplary embodiment, the housing 20 and the tongue 22 are configured as chain links with an opening 38. In the second exemplary embodiment according to FIG. 6, the housing 20 and the tongue 22 are each configured as chain links with a hook 40. At its ends, the neck part 28 respectively comprises a connecting region. In the specific case of the design according to FIG. 6, this connecting region 42 is formed on both ends by an opening of the adjacent normal chain link 30. Alternatively, the connecting region can be configured as a hook. Generally, the connecting region 42 is configured so as to cooperate either with a hook 40 or with an opening 38. In a first exemplary embodiment, the neck part 28 is not shown; it is to be configured in such a manner that the connecting regions 42 of the neck part 28 are configured as a hook.

The locking tongue 22 comprises a tongue body 44 and an end piece 46. The locking tongue 22 is composed of a sheet-metal blank as shown in FIG. 3 and a handling means 50. The latter is preferably manufactured from plastic and is connected, at the free end of the locking tongue 22, with the blank. As the distance to the free end increases, the handling means 50 distances itself from the blank; here, a V-shaped gap is opened which opens in the opposite direction to the plug-in direction 24. The blank is bent about a first bending line 52. This first bending line 52 separates the tongue body from the end piece 46. Bending takes place over an angle 51 which is between 5° and 45°. If the handling means 50 is depressed at a distance from the free end, the handling means yields.

The housing 20 comprises a housing body 54 and an end piece 46. The end pieces 46 each have an opening 38. This opening is preferably configured like the openings in the links 30, 32. The housing 20 is manufactured from a blank as it is shown in FIG. 2. The bending lines 56, 58, 60 are drawn in into FIG. 4. Starting from the flat structure as shown in FIG. 4, the blank is bent about two second bending lines 56, in each case by a right angle upwards out of the paper plane; these second bending lines 56 are parallel to each other. It is then bent about two third bending lines 58, again by 90°, but now in such a way that the approximately rectangular border areas located outside the third bending lines 58 are folded inwards. Thus, their free ends virtually meet. On the whole, a cuboid cavity is thus defined. Finally, more bending is carried out about a fourth bending line 60; this extends at a right angle to the second and third bending line. The third bending lines 58 are also parallel to each other. Bending about the fourth bending line 60 is done at an angle between 10° and 60°. The angle 61 of about 30° can be seen in FIG. 1. The fourth bending line 60 separates the housing body from the end piece 46. It is possible to carry out further bending, e.g. about the bending line 61, see FIG. 4.

The housing 20 has a recess 62; the handling means 50 can engage into this recess, thereby ensuring the interlock.

As FIG. 1 shows, the housing forms a mounting opening 64. It extends transversely to the plug-in direction 24; furthermore, it extends substantially parallel to a central axis 66 of the collar. The latter is the axis of a neck of a dog. This central axis 66 becomes clear when the collar according to FIG. 6 is closed to form a ring; the central axis 66 is then the axis of the ring.

The mounting opening 64 accommodates the leash ring 66. In the exemplary embodiment shown, the leash ring is configured as a D-shaped ring. However, it can also be configured as a circular ring. The D-shaped ring has a linear area formed by the bar of the D. This linear area extends through the mounting opening 64. The arc of the D protrudes towards the outside. The mounting opening 64 is delimited by a section of an internal surface of the end piece 46 of the housing 20. It is further delimited by a projection 68. This projection is formed on a bottom of the housing body 54. Described in another way, it is a section of the rectangular border area. Moreover, the mounting opening 64 is delimited by end faces 70 respectively formed on the side surfaces of the housing body 54. The leash ring 26 can only move within an angular range of about 20° to 50°, the center of which is the axis of the mounting opening 64. When pivoting in the direction towards the end piece 46, the leash ring 26 strikes against stops 72. When pivoting in the opposite direction, it strikes stops that form the end faces 70 together with the material in the transitional area between the end piece 46 and the housing body 54. The mounting opening 64 has a center line; it is drawn into FIG. 1 in a dash-dotted line and extends transversely to the plug-in direction 24 and substantially parallel to a central axis 66 of the collar. This center line is also the center line of the linear area.

Preferably, means are provided that prevent the leash ring 26 from rattling against the housing 20. For this purpose, the leash ring 26 can comprise a plastic jacket or be manufactured from plastic. The housing 20 can be coated with plastic on those surfaces that come into contact with the leash ring 26.

The housing 20 is preferably made from stainless-steel sheet. Other configurations are possible.

In an alternative that is not shown the leash ring can also be disposed on the locking tongue 22. For this purpose, at least one eyelet grasping around the leash ring 26 is disposed, for example, in the end piece 46 of the locking tongue 22.

FIGS. 7 to 10 show a third exemplary embodiment. This differs from the two exemplary embodiments discussed so far by a safety feature. The applicant seeks protection for this safety feature in combination with the features of claims 1 to 4, but also independently thereof. The tongue body 44 now comprises two parts. They are displaceable relative to each other. As is the case in the previous exemplary embodiments, the tongue body 44 comprises a handling means 50 and a sheet-metal blank as shown in FIG. 3. The two are interconnected, with the above-described V-shaped gap already in existence between them. The difference to the previous exemplary embodiments lies in the fact that a safety part 74 is associated with the handling means 50. In the exemplary embodiment shown, the handling means 50 has a slot 76. It extends in the plug-in direction. Viewed in the direction of the central axis 66, it is located centrally in the handling means 50. The safety part 74 is guided in this slot 76 so as to be displaceable between a locking position and a release position. The release position is shown in FIGS. 7 to 9. In the locking position, the safety part 74 is located at the other end of the slot.

The safety part 74 has an actuation region 78 which is preferably located slightly above the external surface of the handling means 50 so that it can be seen clearly and grasped well. Moreover, the safety part comprises a locking body 80. In the exemplary embodiment, the latter has the shape of a blunt wedge. Other shapes are possible. This wedge expands at a distance from the free end of the locking tongue 22, as can be seen, in particular, in FIG. 9. As can be seen from FIG. 10, a guiding region 82 is located between the actuation region 78 and the locking body 80. The guiding region 82 is disposed in the slot 76. In the exemplary embodiment shown, the actuation region 78 is slightly narrower than the width of the slot 76, but significantly shorter, at least three times, preferably 3.5 times shorter than the slot 76, so that the actuation region 78 can be inserted into the slot 76 from below (seen in FIGS. 7 and 8).

In the slot 76, lateral guiding strips 84 are provided on the lateral slot walls, only one of which is visible in the Figures; the other one is located on the opposite slot wall and is constructionally identical. In the state of FIGS. 7 and 8, the guiding strips 84 rest against the guiding region 82 or are located in its immediate vicinity. The actuation region 78 rests on a shoulder forming the guiding strip 84. Thus, it cannot be depressed into the slot 76 in the position according to FIGS. 7 and 8. The guiding strips 84 extend only over a part of the length of the slot 76. They extend over the part of the slot 76 distant from the free end of the locking tongue 22. The guiding strips 84 are not provided in the part of the slot 76 close to the free end, as can be seen clearly from FIG. 7. The front end of the guiding strip 84 is disposed at a distance from the front end of the slot 76 which is no smaller than the corresponding length of the actuation region 78. Thus, assembly can be carried out as follows. If the actuation region 78 is to be connected to the handling means 50, the actuation region 78 of the safety part 74 is inserted from below at the wider part of the slot 76, where there are no guiding strips 84, and the safety part 74 is then pushed into the position apparent from FIGS. 7 and 8. Other embodiments are possible; for example, the slot 76 can extend up to the front end of the handling means 50, the safety part 74 in any configuration can then be inserted into the slot 76, and the handling means 50 can be connected to the sheet-metal blank according to FIG. 3 not until later.

In an advantageous embodiment, the actuation region 78 is selected so as to be as large as possible; it can constitute at least 50%, preferably at least 75% of the surface of the handling means 50.

The wedge angle of the locking body 80 is preferably in the range of a self-locking action, taking into consideration the materials used. Thus, the safety part 74 is unable to move independently in the slot 76 relative to the handling means 50. The locking body 80 is configured as follows: If the safety part 74 is in the release position as shown by FIGS. 7 and 8, a bottom surface of the locking body 80 has no contact with the adjacent opposite surface of the sheet-metal blank as shown, for example, in FIG. 3. Rather, there is a sufficiently large air gap between the two which enables the handling means to yield elastically towards the sheet-metal blank, as is required for the click process or snap-in process during the transition from FIG. 7 to FIG. 8. In the release position, the safety part 74 thus is unnoticeable; in this respect, there is no difference functionally to the two exemplary embodiments described above.

In the locked position of the click fastener as shown by FIG. 8, the safety part 74 can now be displaced in the direction of the arrow 86 in order to reach the secured position of the fastener. If the safety part 74 is displaced in accordance with the arrow 86 towards the free end of the locking tongue 22, the locking body 80 comes to rest against the surface of the sheet-metal blank and keeps the handling means 50 in its elastically extended position, i.e. in its locking position. The handling means 50 now cannot be depressed; it remains caught in the recess 62. The click fastener now cannot be released until the safety part 74 is pushed back into the position according to the FIGS. 7 and 8. It is not until then that the handling means 50 can yield elastically in a downward direction due to pressure and can be moved downwards to such an extent that it is released from the recess 62.

In the collar, the housing 20 preferably comprises a housing body 54 and the housing body 54 and the end piece of the housing 20 are disposed relative to each other at an angle of 10° to 60°, preferably about 40° to 45°.

In the collar, the locking tongue 22 preferably comprises a tongue body 44, and the tongue body 44 includes with the end piece of the locking tongue 22 an angle of between 5 and 45°, preferably about 30°.

In the collar, the housing 20 is preferably manufactured starting with a sheet-metal blank bent about several bending lines 56-60 to form the finished housing 20.

In the collar, the mounting opening 64 is preferably limited by a free end of the locking tongue 22.

In the collar, the housing 20 preferably comprises stops 72 for the pivoting movement of the leash ring 26.

In the collar, the mounting opening 64 is preferably located forward of the locking tongue 22 in the plug-in direction.

In the collar, the mounting opening 64 is preferably limited by the end piece of the housing 20.

In the collar, the housing body 54 preferably has a bottom, the bottom has a projection 68, and the mounting opening 64 is limited by the projection 68.

In the collar, the housing body 54 preferably has side walls, each side wall has an end face 70, and the mounting opening 64 is limited by the end face 70.

In the collar, the leash ring 26 is preferably disposed at an angle greater than 10° relative to the plug-in direction.

In the collar, the leash ring 26 is preferably disposed at an angle greater than 10° relative to the housing 20 including its end piece.

In the collar, it is preferred that, either, an opening 38 is formed in an end piece and a hook 40 reaching through the opening 38 is formed in the adjacent connecting region, or a hook 40 is formed on an end piece and an opening 38 through which the hook 40 reaches is formed in the adjacent connecting region.

The applicants reserve the right to combine any features and sub-features of individual sentences of the description and/or of individual claims in any way, even if such a combination is not expressly discussed. Any combination of features and sub-features is provided.

1-10. (canceled)

11. A collar for animals comprising:
a click fastener having a housing and a locking tongue adapted to be plugged together in a plug-in direction, wherein the housing and locking tongue each include an end piece at a respective end thereof, the click fastener further including a mounting opening having a center line extending transversely to the plug-in direction and substantially parallel to a central axis of the collar;
a leash ring pivotally retained in the mounting opening and adapted for detachable attachment of a leash thereto, and;
a neck part having two connecting regions, wherein one of the connecting regions is connected to the end piece of the housing, and the other of the connecting regions is connected to the end piece of the locking tongue, and adapted to form a ring when the housing and locking tongue are plugged together.

12. A collar according to claim 11, wherein the leash ring comprises a D-shaped ring having a linear portion pivotally retained in the mounting opening.

13. A collar according to claim 12, wherein one of the end piece of the housing and the end piece of the locking tongue defines an opening therein, and the mounting opening is located in the immediate vicinity thereof and close to the opening thereof.

14. A collar according to claim 12, wherein one of the housing and the locking tongue defines the mounting opening.

15. A collar according to claim 14, wherein one of the end piece of the housing and the end piece of the locking tongue defines an opening therein, and the mounting opening is located in the immediate vicinity thereof and close to the opening thereof.

16. A collar according to claim 11, wherein one of the housing and the locking tongue defines the mounting opening.

17. A collar according to claim 11, wherein one of the end piece of the housing and the end piece of the locking tongue defines an opening therein, and the mounting opening is located in the immediate vicinity thereof and close to the opening thereof.

18. A collar according to claim 11, wherein the locking tongue further includes a handling means and a safety part displaceable relative to the handling means in a direction substantially aligned with the plug-in direction between a locking position and a release position, and the housing also includes a recess adapted for latching the handling means therein, wherein in the locking position the handling means is not removable from the recess, and in the release position the handling means is removable from the recess.

19. A collar according to claim 25, wherein the handling means further comprises a slot, and the safety part is disposed in the slot.

20. A collar according to claim 25, wherein the locking tongue further includes a wedge-shaped intermediate space located between the handling means and a base portion of the locking tongue.

21. A collar according to claim 20, wherein the safety part further comprises a locking body located in the intermediate space.

22. A collar according to claim 25, wherein the handling means further comprises an external surface located on a top side of the handling means facing towards outside and defining a surface area having a first size, and the safety part comprises an actuation region defining a surface area having a second size, wherein the second size is at least 50% of the size of the first size.

23. A collar according to claim 22, wherein the second size is at least 70% of the size of the first size.

24. A collar according to claim 22, wherein the actuation region is slightly raised relative to the external surface of the handling means.

25. A collar for animals comprising:
a click fastener having a housing and a locking tongue adapted to be plugged together in a plug-in direction, wherein the housing and locking tongue each include an end piece at a respective end thereof, the locking tongue further including a handling means and a safety part displaceable relative to the handling means in a direction substantially aligned with the plug-in direction between a locking position and a release position, and the housing also includes a recess adapted for latching the handling means, wherein in the locking position the handling means is not removable from the recess, and in the release position the handling means is removable from the recess;
a leash ring adapted for detachable attachment of a leash thereto, and;
a neck part having two connecting regions, wherein one of the connecting regions is connected to the end piece of the housing, and the other of the connecting regions is connected to the end piece of the locking tongue, and adapted to form a ring when the housing and locking tongue are plugged together.

26. A collar according to claim 11, wherein the collar is a collar for dogs.

27. A collar according to claim 25, wherein the collar is a collar for dogs.
